(19) United States
(12) Patent Application Publication
(10) Pub. No.: US 2024/0329268 A1
(43) Pub. Date: Oct. 3, 2024

(54) METHOD AND SYSTEM FOR DEGHOSTING

(71) Applicant: SAUDI ARABIAN OIL COMPANY, Dhahran (SA)

(72) Inventors: Dongliang Zhang, Khobar (SA); Constantinos Tsingas, Dhahran (SA)

(73) Assignee: SAUDI ARABIAN OIL COMPANY, Dhahran (SA)

(21) Appl. No.: 18/193,793

(22) Filed: Mar. 31, 2023

(51) Int. Cl. G01V 1/36; E21B 44/00

(52) U.S. Cl. CPC G01V 1/368; E21B 44/00; G01V 2210/22; G01V 2210/43; G01V 2210/44; G01V 2210/48; G01V 2210/56

(57) ABSTRACT

Examples of methods and systems are disclosed. The methods include obtaining seismic data regarding a subsurface region of interest, wherein the seismic data comprises time-space pressure data. The methods also include determining, using a seismic processor, a pressure derivative with respect to depth. The methods further include determining, using the seismic processor, a phase-shifted pressure derivative. The methods still further include determining, using the seismic processor, a transformed phase-shifted pressure derivative. The methods also include determining, using the seismic processor, transformed phase-shifted pressure data based, at least in part, on the transformed phase-shifted pressure derivative. The methods further include determining, using the seismic processor, time-space filtered pressure data. The methods still further include determining, using the seismic processor, a first direction wavefield and a second direction wavefield. The methods also include generating, using the seismic processor, a seismic image based, at least in part, on the first direction wavefield.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and may be detected by seismic receivers. The seismic receivers detect and may store a time-series of samples of earth motion caused by the seismic waves. The collection of time-series of samples recorded at many receiver locations generated by a seismic source at many source locations constitutes a seismic data set.

To determine the earth structure, including the presence of hydrocarbons, the seismic data set may be processed. Processing a seismic data set includes a sequence of steps designed to correct for a number of issues, such as near-surface effects, noise, irregularities in the seismic survey geometry, etc. For example, the presence of a discontinuity, such as a free surface near the source and the receivers, may create unwanted reflections, known as ghosts, that overlap the seismic field of interest. The resulting reflection series may end up being much more populated than the true reflectivity, and the unwanted reflections may cause notches in the spectrum of the recorded wavefield, lowering the useable bandwidth. The removal of ghost events from seismic data is known as deghosting. A properly processed seismic data set may aid in decisions as to if and where to drill for hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method including obtaining seismic data regarding a subsurface region of interest, wherein the seismic data includes time-space pressure data. The method also includes a determining, using a seismic processor, a pressure derivative with respect to depth based on the time-space pressure data. The method further includes determining, using the seismic processor, a phase-shifted pressure derivative by applying a phase-shift filter to the pressure derivative. The method still further includes determining, using the seismic processor, a transformed phase-shifted pressure derivative by decomposing the phase-shifted pressure derivative into components of a frequency and a horizontal wavenumber. The method also includes determining, using the seismic processor, transformed phase-shifted pressure data based, at least in part, on the transformed phase-shifted pressure derivative. The method further includes determining, using the seismic processor, time-space filtered pressure data by inverse transforming the transformed phase-shifted pressure data. The method still further includes determining, using the seismic processor, a first direction wavefield and a second direction wavefield based, at least in part, on the time-space pressure data and the time-space filtered pressure data. The method also includes generating, using the seismic processor, a seismic image based, at least in part, on the first direction wavefield or the second direction wavefield.

In one aspect, embodiments disclosed herein relate to a system including a seismic

acquisition system configured to record seismic data regarding a subsurface region of interest, wherein the seismic data includes time-space pressure data. The system also includes a seismic processor configured to obtain the seismic data regarding a subsurface region of interest. The seismic processor is also configured to determine a pressure derivative with respect to depth based on the time-space pressure data. The seismic processor is further configured to determine a phase-shifted pressure derivative by applying a phase-shift filter to the pressure derivative. The seismic processor is still further configured to determine a transformed phase-shifted pressure derivative by decomposing the phase-shifted pressure derivative into components of a frequency and a horizontal wavenumber. The seismic processor is also configured to determine transformed phase-shifted pressure data based, at least in part, on the transformed phase-shifted pressure derivative. The seismic processor is further configured to determine time-space filtered pressure data by inverse transforming the transformed phase-shifted pressure data. The seismic processor is still further configured to determine a first direction wavefield and a second direction wavefield based, at least in part, on the time-space pressure data and the time-space filtered pressure data. The seismic processor is also configured to generate a seismic image based, at least in part, on the first direction wavefield or the second direction wavefield.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

FIG. 1 shows a seismic acquisition system of a subsurface region of interest in accordance with one or more embodiments of the present disclosure.

FIG. 2 shows a seismic acquisition system of a subsurface region of interest in accordance with one or more embodiments of the present disclosure.

FIG. 3 shows examples of seismic data produced by a seismic acquisition system in accordance with one or more embodiments.

FIG. 4 shows a drilling system in accordance with one or more embodiments.

FIG. 5 shows diagrams of upgoing waves and downgoing waves in accordance with one or more embodiments.

FIG. 6 shows a flowchart in accordance with one or more embodiments.

FIG. 7 shows examples of separation of simulated wavefields in accordance with one or more embodiments.

FIG. 8 shows examples of waveforms of separated simulated wavefields in accordance with one or more embodiments.

FIG. 9 shows examples of separation of acquired wavefields in accordance with one or more embodiments.

FIG. 10 shows examples of spectra of separated acquired wavefields in accordance with one or more embodiments.

FIG. 11 shows a flowchart in accordance with one or more embodiments.

FIG. 12 depicts a schematic diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

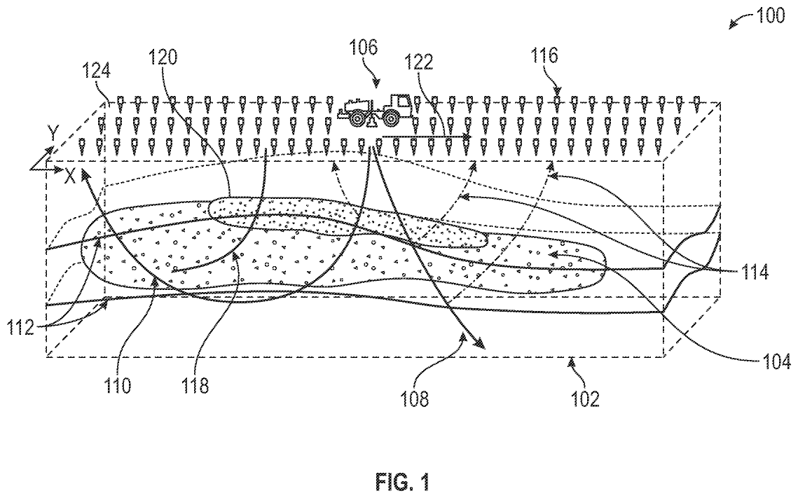

In the following description of FIGS. 1-12, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods to remove ghost events in acquired seismic data. In particular, some embodiments acquire seismic signals during geophysical explorations to map the structure of a subsurface region. The seismic signals may contain ghost events, undesired reflections due to the presence of a free surface close to the source and receivers. In some embodiments, a deghosting technique is applied to remove the ghost events by separating the wavefield in up-going and down-going waves. However, seismic receivers are typically placed at the same vertical position, and determining the up-going and down-going waves may be difficult with such configurations. Methods and processing techniques to reduce ghost events for all types of receiver placement may assist in improving the quality of acquired seismic data.

The deghosted seismic data may then be used for further seismic data interpretation, such as defining the spatial location and extent of a hydrocarbon reservoir. Thus, the disclosed methods are integrated into the established practical applications for improving seismic images and searching for an extraction of hydrocarbons from subsurface hydrocarbon reservoirs. The disclosed methods represent an improvement over existing methods for at least the reasons of lower cost and increased efficacy.

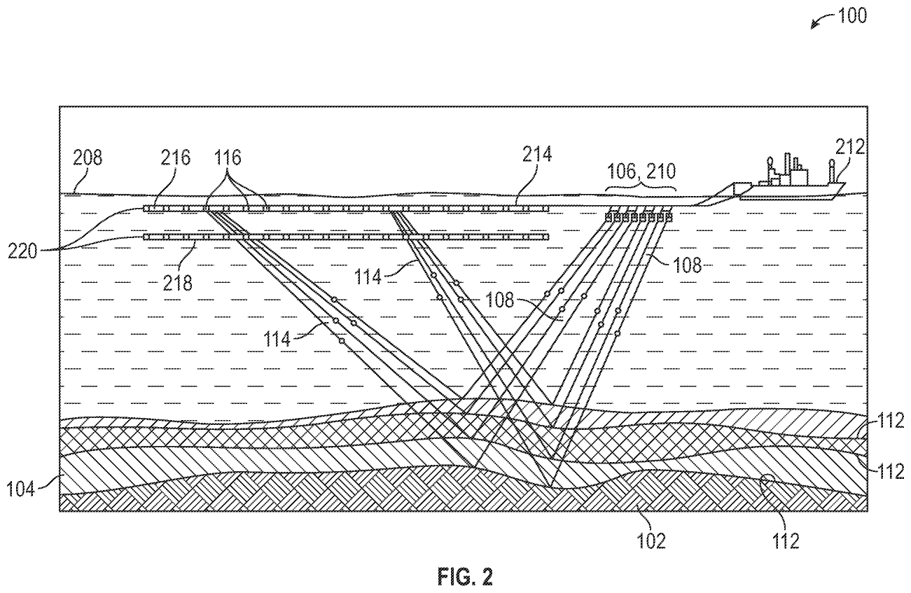

FIGS. 1 and 2 show a seismic acquisition system (100) of a subsurface region of interest (102), according to one or more embodiments. In some cases, the subsurface region of interest (102) may lie beneath a lake, sea, or ocean, as shown in FIG. 2. In other cases, the subsurface region of interest (102) may lie beneath an area of dry land, as shown in FIG. 1. The subsurface region of interest (102) may contain a hydrocarbon deposit (120) that may form part of a hydrocarbon reservoir (104). The seismic acquisition system (100) may utilize a seismic source (106) that generates radiated seismic waves (108). The type of seismic source (106) may depend on the environment in which it is used. For example, on land the seismic source (106) may be a vibroseis truck (130) or an explosive charge, but in water the seismic source (106) may be an airgun (or a series of airguns (210)). FIG. 2 depicts a series of airguns (210) being towed, or pulled, by a vessel (212) while conducting a seismic survey.

The radiated seismic waves (108) may return to the surface (124) of the earth as refracted seismic waves (110) or reflected seismic waves (114). Refracted seismic waves (110) and reflected seismic waves (114) may occur, for example, due to geological discontinuities (112) that may be also known as “seismic reflectors”. The geological discontinuities (112) may be, for example, planes or surfaces that mark changes in physical or chemical characteristics in a geological structure. The geological discontinuities (112) may also be boundaries between faults, fractures, or groups of fractures within a rock. The geological discontinuities (112) may delineate a hydrocarbon reservoir (104).

At the surface (124), refracted seismic waves (110) and reflected seismic waves (114) may be detected by seismic receivers (116). Radiated seismic waves (108) that propagate from the seismic source (106) directly to the seismic receivers (116), known as direct seismic waves (122), are also detected by the seismic receivers (116).

Likewise, as shown in FIG. 2, the radiated seismic waves (108) may return to the surface (208) of the body of water (e.g., lake, ocean, etc.), after being reflected by geological discontinuities (112), as reflected seismic waves (114). Seismic receivers (116) located on or near the surface of the body of water detect the reflected seismic waves (114). As shown in FIG. 2, the seismic receivers (116) may be connected as a buoyant assembly known as a streamer (214) which is also towed by the vessel (212). In some implementations, the seismic receivers (116) are distributed in a horizontal direction at the same depth. In other implementations, the seismic receivers (116) are distributed in pairs (220) in a “dual streamer” configuration consisting of an over streamer (216) and an under streamer (218). In each pair (220) of the dual streamer configuration the seismic receivers may be positioned at the same horizontal location but at two different depths.

In some embodiments, a seismic source (106) may be positioned at a location denoted (xₛ, yₛ), where x and y represent orthogonal axes on the earth's surface above the subsurface region of interest (102). The seismic receivers (116) may be positioned at a plurality of seismic receiver locations denoted (xᵣ, yᵣ), with the distance between each receiver and the source being termed “the source-receiver offset”, or simply “the offset”. Thus, the direct seismic waves (122), refracted seismic waves (110), and reflected seismic waves (114) generated by a single activation of the seismic source (106) may be represented in the axes (xₛ, yₛ, xᵣ, yᵣ, t). The t-axis indicates the recording time between the activation of the seismic acquisition system (100) and the sample time at which the seismic wave is detected by the seismic receivers (116).

Seismic processing may reduce five-dimensional seismic data produced by a seismic acquisition system (100) to three-dimensional (x, y, t) seismic data by, for example, correcting the recorded time for the time of travel from the seismic source (106) to the seismic receiver (116) and summing (“stacking”) samples over two horizontal space dimensions. Stacking of samples over a predetermined time interval may be performed as desired, for example, to reduce noise and improve the quality of the signals.

Seismic data may also refer to data acquired at different time intervals, such as, for example, in cases where seismic surveys are repeated after a period of weeks, months, or years, to obtain time-lapse data. Seismic data may also be pre-processed or partially-processed data, e.g., arranged as “common shot gathers” (CSG), i.e., sorting waveforms as acquired by different receivers and having a single source location. The type of seismic data is not intended as limiting, and any other suitable seismic data is intended to fall within the scope of the present disclosure.

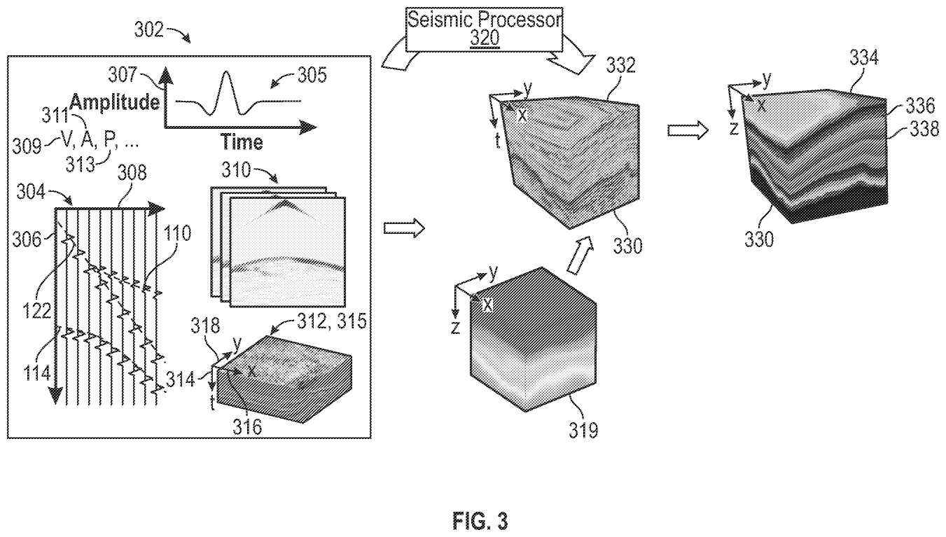

FIG. 3 shows examples of seismic data (302) produced by a seismic acquisition system (100) in accordance with one or more embodiments. An example of a CSG (304) illustrates direct seismic waves (122), refracted seismic waves (110), and reflected seismic waves (114) generated by a single activation of the seismic source (106) and recorded by a several seismic receivers (116) arranged in a line in a horizontal direction. Each seismic receiver (116) may record a time series (305) representing the amplitude of ground-motion at a sequence of discrete times. This time-series may be denoted or otherwise referred to as a “waveform”. The amplitude (307) of the waveform may quantify, for example, one or more components of particle velocity (309) or particle acceleration (311) along orthogonal axes, or pressure (313) at the seismic receiver (116) location.

In the CSG (304) shown in FIG. 3 the vertical axis (306) represents the time scale and the horizontal axis (308) represents the offset. In some embodiments, direct seismic waves (122), refracted seismic waves (110), and reflected seismic waves (114) may be identified in the CSG (304) by their arrival times, i.e., the times at which they are first detected by the seismic receivers (116). The location of a particular type of wave in seismic data (302) acquired in time and space, such as in CSG (304), may be termed as an “arrival” or as an “event”.

The CSG (304) illustrates how arrivals are detected at later times by the seismic receivers (116) that are farther from the seismic source (106). In some embodiments, arrivals of direct seismic waves (122) in the CSG (304) may be approximated by a straight line, while arrivals of reflected seismic waves (114) may present a hyperbolic shape, as seen in FIG. 3. In contrast refracted seismic waves (110) may be characterized by arrivals approximating a straight line but with a finite arrival time at zero offset.

In one or more embodiments, seismic data (302) acquired by a seismic acquisition system (100) may be arranged in a plurality of CSGs (310) to create a 3D seismic dataset. Alternatively, the seismic data (302) may be represented as a “seismic volume” (312) consisting of a plurality of time-space waveforms with a time axis (314), a first spatial dimension (316), and a second spatial dimension (318), where the first spatial dimension (316) and second spatial dimension (318) are orthogonal and span the Earth's surface above the subsurface region of interest (102). Seismic data (302) may also include time-space pressure data (315) in the form of time-space waveforms that describe the time variation of pressure (313) at the seismic receivers (116).

Seismic data (302) may be processed by a seismic processor (320) to generate a seismic velocity model (319) of the subterranean region of interest (102). A seismic velocity model (319) is a representation of seismic velocity at a plurality of locations within a subterranean region of interest (102). Seismic velocity is the speed at which a seismic wave, that may be a pressure-wave or a shear-wave, travel through a medium. Pressures waves are often referred to as “primary-waves” or “P-waves”. Shear waves are often referred to as “secondary-waves” or “S-waves”. Seismic velocities in a seismic velocity model (319) may vary in vertical depth, in one or more horizontal directions, or both. Layers of rock are created from different materials or created under varying conditions. The seismic velocity may vary from one rock formation or layer to the next.

In some embodiments seismic data (302) may be processed by a seismic processor (320) to generate a seismic image (330) of the subterranean region of interest (102). Seismic data (302) may easily be of the order of hundreds of terabytes in size, thus manual seismic processing is essentially impractical and processing a full seismic dataset may require substantial computer resources, including both computer processing and computer memory capabilities. In some embodiments, a seismic processor (320) may consist of computer hardware components that are specifically configured for the purpose of efficiently performing seismic processing steps. For example, a seismic processor (320) may typically include an array of computer-processing units (CPUs) with one or more subarrays of graphical processing units (GPUs) attached to each CPU. Tape readers or high-capacity hard-drives may be connected to the CPUs using wide-band data buses. In some cases, the seismic processor (320) may be co-located with the seismic analyst operating the system, while in other cases the seismic processor (320) may be implemented remotely from the seismic analysts, such as on “the cloud”, i.e., on computer hardware leased from a third-party at a remote location. In the latter case, the seismic analyst may perform command, control and QC on a local computer system and transmit instructions to and receive summary data from the seismic processor (320) over a network, including a secure network such as a virtual private network (VPN). A seismic analyst may interface with the seismic processor (320) on one or more computer monitors where visualization of the seismic data, the results of intermediate processing steps, and/or the final seismic image (330) or attribute image may be displayed. These displays may include perspective visualization of 3D image cubes, planar vertical or horizontal slices, and non-planar surfaces (such as an undulating geological surface). In other cases, the seismic data (302) may be displayed using virtual reality technology (e.g., goggles or “caves”) that allow the seismic analyst to “walk through” the seismic data).

Processing seismic data (302) may generate a time-domain seismic image (332) using a process called seismic migration (also referred to as “migration” herein) and a seismic velocity model (319). In seismic migration, seismic events (e.g., reflections, refractions) recorded at the surface are relocated in either time or space to the location the event occurred in the subsurface. In some embodiments, migration may transform pre-processed shot gathers from a time-domain to a depth-domain seismic image (334). In a depth-domain seismic image (334), seismic events in a migrated shot gather may represent geological boundaries (336, 338) in the subsurface. Various types of migration algorithms may be used in seismic imaging. For example, one type of migration algorithm corresponds to reverse time migration.

Processing of seismic data (302) may generate a seismic image (330). The seismic image (330) may be interpreted by a seismic interpreter using a seismic interpretation workstation as containing structures, including geological boundaries (336, 338) delineating the three-dimensional geometry of a subsurface region of interest (102) including, for example, a hydrocarbon reservoir (104). If a seismic image (330) indicates the presence of hydrocarbons in the subsurface region of interest (102), a drilling system may drill a wellbore (118) to access those hydrocarbons.

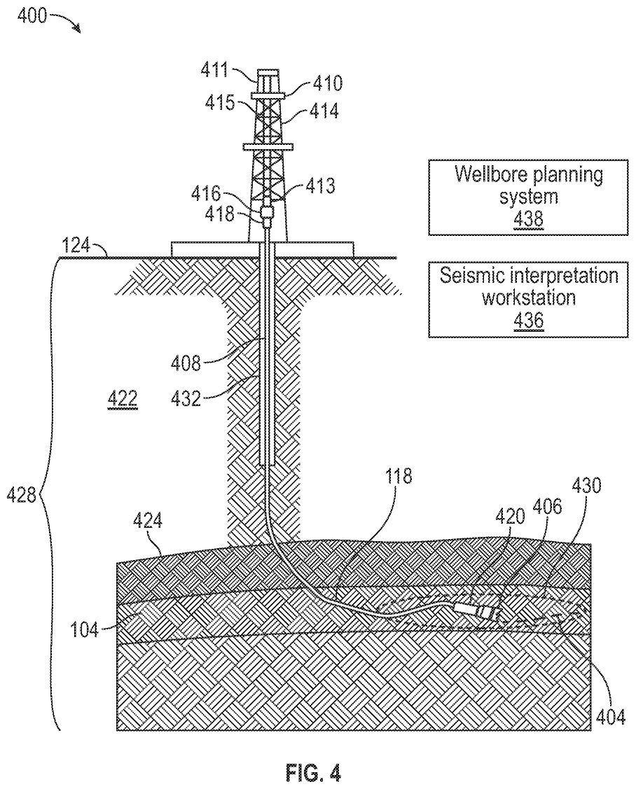

FIG. 4 shows a drilling system (400) in accordance with one or more embodiments. As shown in FIG. 4, a wellbore (118) following a wellbore trajectory (404) may be drilled by a drill bit (406) attached by a drillstring (408) to a drilling rig (410) located on the surface (124) of the earth. The drilling rig (410) may include framework, such as a derrick (414) to hold drilling machinery. A crown block (411) may be mounted at the top of the derrick (414), and a traveling block (413) may hang down from the crown block (411) by means of a cable (415) or drilling line. One end of the cable (415) may be connected to a drawworks (not shown), which is a reeling device that may be used to adjust the length of the cable (415) so that the traveling block (413) may move up or down the derrick (414).

A top drive (416) provides clockwise torque via the drive shaft (418) to the drillstring (408) in order to drill the wellbore (118). The drillstring (408) may comprise a plurality of sections of drillpipe attached at the uphole end to the drive shaft (418) and downhole to a bottomhole assembly (“BHA”) (420). The BHA (420) may be composed of a plurality of sections of heavier drillpipe and one or more measurement-while-drilling (“MWD”) tools configured to measure drilling parameters, such as torque, weight-on-bit, drilling direction, temperature, etc., and one or more logging-while-drilling (“LWD”) tools configured to measure parameters of the rock surrounding the wellbore (118), such as electrical resistivity, density, sonic propagation velocities, gamma-ray emission, etc. MWD and logging tools may include sensors and hardware to measure downhole drilling parameters, and these measurements may be transmitted to the surface (124, 102) using any suitable telemetry system known in the art. The BHA (420) and the drillstring (408) may include other drilling tools known in the art but not specifically listed.

The wellbore (118) may traverse a plurality of overburden (422) layers and one or more seals or cap-rock formations (424) to a hydrocarbon reservoir (104) within the subterranean region (428), and specifically to a drilling target (430) within the hydrocarbon reservoir (104). The wellbore trajectory (404) may be a curved or a straight. All or part of the wellbore trajectory (404) may be vertical, and some portions of the wellbore trajectory (404) may be deviated from the vertical or horizontal. One or more portions of the wellbore (118) may be cased with casing (432) in accordance with a wellbore plan.

To start drilling, or “spudding in” the well, the hoisting system lowers the drillstring (408) suspended from the derrick (414) towards the planned surface location of the wellbore (118). An engine, such as an electric motor, may be used to supply power to the top drive (416) to rotate the drillstring (408) through the drive shaft (418). The weight of the drillstring (408) combined with the rotational motion enables the drill bit (406) to bore the wellbore (118).

The drilling system (400) may be disposed at and communicate with other systems in the well environment, such as a seismic processor (320) and a wellbore planning system (438). The drilling system (400) may control at least a portion of a drilling operation by providing controls to various components of the drilling operation. In one or more embodiments, the drilling system (400) may receive well-measured data from one or more sensors and/or logging tools arranged to measure controllable parameters of the drilling operation. During operation of the drilling system (400), the well-measured data may include mud properties, flow rates, drill volume and penetration rates, rock physical properties, etc.

In some embodiments, the rock physical properties may be used by a seismic interpretation workstation (436) to determine a location of a hydrocarbon reservoir (104) (or other subterranean features). The seismic interpretation workstation (436) may be used to identify and label subsurface structures, such as geological layers, geological layer boundaries, faults and fractures, and boundaries between different types of pore fluids. Typically a seismic interpretation workstation (436) may be configured to facilitate interaction between the seismic interpretation workstation (436), the seismic data (302) and images stored within the seismic interpretation workstation (904) and a human user. To achieve this the seismic interpretation workstation (436) may be equipped with two-dimensional (monitors) or three-dimensional (immersive or virtual reality) display capabilities and one or more mouse, wand, or equivalent devices designed to enable the identification, isolation, and labelling of subterranean features.

Knowledge of the existence and location of the hydrocarbon reservoir (104) and other subterranean features may be transferred from the seismic interpretation workstation (436) to a wellbore planning system (438). The wellbore planning system (438) may use information regarding the hydrocarbon reservoir (104) location to plan a well, including a wellbore trajectory (404) from the surface (124) of the earth to penetrate the hydrocarbon reservoir (104). In addition, to the depth and geographic location of the hydrocarbon reservoir (104), the planned wellbore trajectory (404) may be constrained by surface limitations, such as suitable locations for the surface position of the wellhead, i.e., the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (404) may be transferred to the drilling system (400) described in FIG. 4. The drilling system (400) may drill the wellbore (118) along the planned wellbore trajectory (404) to access the drilling target (430) in the hydrocarbon reservoir (104).

A seismic image (330) of high quality may assist in improving the accuracy of the planned wellbore trajectory (404), and thus the efficiency of the drilling operations. A seismic image (330) of high resolution be obtained if densely-recorded data is acquired by using closely-spaced shots and seismic receivers. For example, seismic waves with a bandwidth extending up to 100 Hz or more may resolve thin features. However, when receivers are located at a depth below the surface (124, 208), as it is often the case in seismic acquisition systems in water (see FIG. 2), seismic data (302) may be contaminated with downgoing waves.

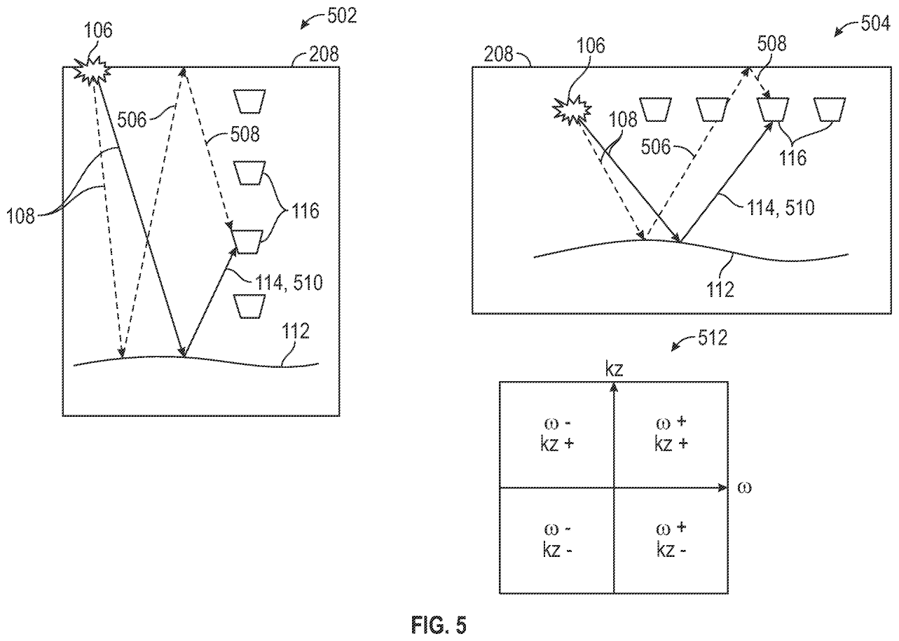

FIG. 5 illustrates examples of configurations of seismic receivers (116) disposed in water, according to one or more embodiments. In diagrams (502) and (504) the receivers are distributed in a vertical (depth) and a horizontal direction, respectively. Both diagrams (502, 504) include a seismic source (106) that generates radiated seismic waves (108) that are reflected at a geological discontinuity (112), and the corresponding reflected seismic waves (114) that arrive at the seismic receivers (116). As illustrated in FIG. 5, the reflected seismic waves (114) and refracted waves (not shown) of interest, which carry information about the geological discontinuities (112), arrive at the seismic receivers (116) as upgoing waves (510). However, when the seismic receivers (116) are located at some distance below the surface (208), there may also be early reflected waves (506) that arrive first at the surface (208) where they are reflected generating downgoing waves (508) that are then detected by the seismic receivers (116).

The downgoing waves (508) are often called “ghosts” since they may manifest themselves in a time series (305) as slightly delayed phases trailing the seismic waves of interest. The downgoing waves (508) may interfere with the upgoing waves (510) of interest in a constructive or destructive manner, causing phase and amplitude changes of the desired upgoing wavefields (510), which may result in loss of resolution and bandwidth. This phenomenon is known in seismic data processing as the “ghost-notch” effect.

The process of eliminating the interfering downgoing waves (508) from seismic data (302) is known as deghosting. Different approaches may be adopted to address the deghosting problem: acquisition-based, statistical processing, and deterministic processing. Acquisition based approaches involve making use of special acquisition configurations, for example using dual-streamer configurations or using variable-depth streamer configurations. Statistical processing approaches may include the classical minimum phase deconvolution algorithm or machine learning techniques, among others. Deterministic processing approaches include the computation of the analytic inverse of the ghost operator, and the estimation of unrecorded quantities from the data and using these quantities to deghost the data. A processing-based approach to deghosting may be a convenient solution because data processing may be applied to existing, already acquired seismic data (302).

One conventional deterministic processing approach to deghosting involves separating the downgoing waves (508) from the upgoing waves (510) detected at the seismic receivers (116). The recorded wavefield may be interpreted as a convolution of the upgoing waves (510) and a ghosting operator. The up/down separation of the wavefields is then performed by estimating in a deterministic manner the ghosting operator. In the frequency domain the ghosting operator may be expressed as:

$$G ( ω ) = 1 + r exp ( i ω {t}_{d} ) \qquad Equation ( 1 )$$

where ω is the circular frequency, i=\sqrt{−1}, and t_{d} is the two-way vertical propagation time from the source (or receiver). The parameter r belongs to the range −1<r<0 and is the magnitude of the reflectivity coefficient at the surface. A value of −1 may be used for the reflectivity coefficient r, however, the reflectivity at the water surface is not always equal to −1, and in many cases, it is not even known.

In some embodiments, deghosting is based on a method that uses the Hilbert Transform and does not involve the use of a reflectivity coefficient. Specifically, up/down separation of wavefields is based on the sign of the apparent propagation velocity v_{z}, or slowness p_{z} along the vertical (depth) axis. For seismic wavefields in a time-space (t, z) domain the apparent propagation velocity v_{z} may be obtained by transforming the (t, z) data into frequency-vertical wavenumber data, with the 1D dispersion relation:

$${v}_{z} = ω / {k}_{z} \qquad Equation ( 2 )$$

where k_{z} is the vertical wavenumber. Although only the sign of v_{z} is used to perform the up/down separation of wavefields, it depends on the signs of ω and k_{z}, both of which may be positive or negative, leading to four possibilities, as shown in diagram (512) in FIG. 5. Diagram (512) illustrates the signs of ω and k_{z} in the four quadrants of the frequency-vertical wavenumber domain.

The Hilbert Transform may be used as a tool to produce complex time histories that are equivalent (i.e., with no loss of information) to the original time series (305) included in seismic data (302). The original time series (305) may be considered as real functions of time and space, whereas the complex time histories produced with the Hilbert Transform have a real and an imaginary part, but with the advantage of having only non-negative frequencies or wavenumbers. Specifically, The Hilbert Transform allows the construction of the complex counterpart of a real-valued function (or signal) f(t), also known as the “analytical signal” or “complex trace” A(t), given by:

$$A ( t ) = f ( t ) + i {H}_{t} \{ f ( t ) \} \qquad Equation ( 3 )$$

where the imaginary part A(t) is the Hilbert Transform of f(t), denoted by Hₜ{f(t)}. The Hilbert Transform of f(t) mat expressed as the Cauchy Principal Value of the following integral:

$${H}_{t} \{ f ( t ) \} = \frac{1}{π} {\int }_{- ∞}^{∞} \frac{f ( τ )}{t - τ} d τ \qquad Equation ( 4 )$$

It follows that the Hilbert Transform Hₜ of a real time-domain signal f(t) is a linear time-invariant filter that produces another real-valued time-domain signal Hₜ{f(t)}.

The filtering effect of the Hilbert Transform Hₜ on the signal f(t) may be more clearly understood in the frequency domain. The fact that the Fourier Transform Fₜ of a time-domain signal is a function of a temporal frequency ω may be expressed as:

$${F}_{t} \{ f ( t ) \} = {ℱ}_{t} ( ω ) \qquad Equation ( 5 )$$

where [symbol] ₜ(ω) denotes the Fourier Transform of f(t). Note that if the signal to be transformed is a function of a spatial coordinate, say for example g(x), the Fourier Transform is a function of a spatial frequency, [symbol] ₓ(kₓ), also known, as wavenumber kₓ. In the notation adopted herein the subscript of the transform, Hilbert of Fourier, denotes the variable to which the Transform is applied. For example, for transformations with respect to the time variable of a function of the form g(t, x), the Hilbert transform and the Fourier Transform are denoted by Hₜ{g(t, x)} and Fₜ{g(t, x)}, respectively. Similarly, for transformations of g(t, x) with respect to the space variable x, the Hilbert transform and the Fourier Transform are denoted by Hₓ{g(t, x)} and Fₓ{g(t, x)}, respectively. Keeping with the time-domain signal, the Fourier Transform of the Hilbert Transform, denoted by [symbol] ₜ(ω), is related to [symbol] ₜ(ω) as follows:

$${F}_{t} \{ {H}_{t} \{ f ( t ) \} \} = {ℋ}_{t} ( ω ) = - i sgn ( ω ) {ℱ}_{t} ( ω ) \qquad Equation ( 6 )$$

where sgn(·) is the sign function of its argument. Since the Fourier Transform [symbol] ₜ(ω) is a complex function, each of its frequency components has a real part and an imaginary part, or equivalently, each of its frequency components has an amplitude and a phase. Therefore, the multiplication of [symbol] ₜ(w) by the factor—i sgn(ω) implies that the Hilbert Transform essentially exchanges the real and imaginary parts of [symbol] ₜ(ω) (while changing the sign of one of them). This exchange of real and imaginary parts may be interpreted in the complex plane as a rotation from a real-to-imaginary axis, or from an imaginary-to-real axis. In addition, a rotation between the real and imaginary axis in the complex plain is equivalent to a phase shift of ±π/2 radians to each frequency component of [symbol] ₜ(ω). Thus, the Hilbert Transform does not change the magnitude of [symbol] ₜ(ω), only its phase, with a ±π/2 phase shift. Note that the Hilbert transform may be used to apply a ±π/2 phase shift to temporal frequency components ω, as well as spatial frequency (wavenumber) components.

Applying the Fourier Transform to the analytical signal A(t) to Equation (3), along with Equation (6), gives the result:

$$𝒜 ( ω ) = {ℱ}_{t} ( ω ) + sgn ( ω ) {ℱ}_{t} ( ω ) \qquad Equation ( 7 )$$

which may be equivalently expressed as:

$$𝒜 ( ω ) = \{ \begin{matrix}ℱ ( 0 ) , & ω = 0 \\ 2 ℱ ( ω ) , & ω > 0 \\ 0 , & ω < 0\end{matrix} \qquad Equation ( 8 )$$

As seen in Equation (8), the Fourier Transform [symbol] (ω) of the analytical signal A(t) has no negative frequency components. The analytical signal A(t) may then be used as a tool to extract the positive frequency components of a signal f(t). Furthermore, a generalization of the analytical signal A(t) provides what is known as the Extended Hilbert Transform Eₜ^{±}, given by the following expression:

$${E}_{t}^{\pm } \{ f ( t ) \} = f ( t ) \pm i {H}_{t} \{ f ( t ) \} \qquad Equation ( 9 )$$

Application of the Extended Hilbert Transform Eₜ^{±} to the signal f(t) allows then a straightforward separation of positive and negative frequency components in the frequency domain, as given in the following expressions:

$${𝔼}_{ω}^{+} \{ f ( t ) \} = \{ \begin{matrix}2 {ℱ}_{t} ( ω ) , & ω \geq 0 \\ 0 , & ω < 0\end{matrix} \qquad Equation ( 10 )$$

$${𝔼}_{ω}^{-} \{ f ( t ) \} = \{ \begin{matrix}0 , & ω \geq 0 \\ 2 {ℱ}_{t} ( ω ) , & ω < 0\end{matrix}$$

where [symbol] and [symbol] are respectively the positive and negative frequency components of f(t) in the frequency domain. As already stated below, the Hilbert Transform and therefore, Equations (9) and (10), may be applied to separate temporal frequency components as well as spatial frequency (wavenumber) components of a signal.

In particular, for a wavefield p(t, z) defined in time and only in a spatial (vertical or depth, z) dimension, the up/down separation of p(t, z) may be expressed in terms of the Extended Hilbert Transform, as follows:

$${p}_{u} ( t , z ) = \frac{1}{4} {E}_{z}^{-} ( {E}_{t}^{+} ) + \frac{1}{4} {E}_{z}^{+} ( {E}_{t}^{-} ) = \frac{1}{2} p ( t , z ) + \frac{1}{2} {H}_{z} \{ {H}_{t} \{ p ( t , z ) \} \} \qquad Equation ( 11 )$$

$${p}_{d} ( t , z ) = \frac{1}{4} {E}_{z}^{+} ( {E}_{t}^{+} ) + \frac{1}{4} {E}_{z}^{-} ( {E}_{t}^{-} ) = \frac{1}{2} p ( t , z ) - \frac{1}{2} {H}_{z} \{ {H}_{t} \{ p ( t , z ) \} \}$$

where pᵤ(t, z) is the up-going wavefield (510) and p_{d}(t, z) the down-going wavefield (508) of p(t, z). Eₜ^{±} and E_{z}^{±} denote the Extended Hilbert Transform applied to a temporal and a vertical spatial frequency, respectively. Similarly, Hₜ and H_{z} denote the Hilbert Transform applied to a temporal and a vertical spatial frequency, respectively.

Keeping with to FIG. 5, the four quadrants in the frequency-wavenumber domain shown in diagram (512) and denoted by (ω−, k_{z}+), (ω+, k_{z}−), (ω+, k_{z}+), and (ω−, k_{z}−) correspond to the terms E_{z}⁻(Eₜ⁺), E_{z}⁺(Eₜ⁻), E_{z}⁺(Eₜ⁺), and E_{z}⁻(Eₜ⁻), respectively. Therefore, the up-going wavefield pᵤ(t, z) (510) is constructed from components from quadrants where ω and k_{z} have opposite sign (negative apparent velocity, v_{z}). Similarly, the down-going wavefield p_{d}(t, z) (508) is constructed from components from quadrants where ω and k_{z} have the same sign (positive apparent velocity, v_{z}).

However, in some embodiments, the seismic acquisition system (100) uses seismic receivers (116) that are distributed in a horizontal direction, as in the example of diagram (504) in FIG. 5. The seismic data (302) may then be a function of time, and one or more horizontal spatial dimensions, but not of a vertical (depth) spatial dimension. The wavefield may be expressed, for example, in the form p(t, x, y), and the transform H_{z} in Equation (11) cannot be evaluated using Equations (4) or (6) since the data is not a function of depth. However, a wavefield in the form p(t, x, y) may still include upgoing waves (510) and downgoing waves (508) as illustrated in diagram (504), and thus the dispersion relation may be expressed as:

$$\frac{{ω}^{2}}{{v}^{2}} = {k}_{z}^{2} + {k}_{x}^{2} + {k}_{y}^{2} \qquad Equation ( 12 )$$

where kₓ and k_{y} are the wavenumbers in the x- and y-direction, respectively. Acquiring seismic data (302) such as pressure data (315) with horizontally distributed seismic receivers (116) at two or more different depths (as in the example shown in FIG. 2) may make the computation of H_{z} possible. Still, an approach based solely in processing already acquired seismic data (302) may reduce acquisition costs and may assist in deghosting existing datasets.

In some embodiments, the transform H_{z} in Equation (8) may be estimated in an indirectly manner. For a signal g(t, x, y, z), the Fourier Transform applied to the spatial coordinates x, y and z, denoted by G_{x,y,z}, may be expressed as:

$${F}_{x , y , z} \{ g ( t , x , y , z ) \} = {G}_{x , y , z} ( t , {k}_{x} , {k}_{y} , {k}_{z} ) \qquad Equation ( 13 )$$

Then, the Fourier Transform of the partial derivative of g(t, x, y, z) with respect to z, denoted here by D_{x,y,z}, is given by:

$${F}_{x , y , z} \{ \frac{\partial }{\partial z} g ( t , x , y , z ) \} = {D}_{x , y , z} ( t , {k}_{x} , {k}_{y} , {k}_{z} ) = - {ik}_{z} {G}_{x , y , z} ( t , {k}_{x} , {k}_{y} , {k}_{z} ) \qquad Equation ( 14 )$$

On the other hand, taking the Hilbert Transform of the signal g(t, x, y, z) with respect to z, and then applying the Fourier Transform by F_{x,y,z} leads to the result:

$${F}_{x , y , z} \{ {H}_{z} \{ g ( t , x , y , z ) \} \} = - i sgn ( {k}_{z} ) {G}_{x , y , z} ( t , {k}_{x} , {k}_{y} , {k}_{z} ) \qquad Equation ( 15 )$$

Combining Eqs. (14) and (15) the following result is obtained:

$${F}_{x , y , z} \{ {H}_{z} \{ g ( t , x , y , z ) \} \} = - \frac{{D}_{x , y , z} ( t , {k}_{x} , {k}_{y} , {k}_{z} )}{\vert {k}_{z} \vert} \qquad Equation ( 16 )$$

Next, the Fourier Transform with respect to time applied on both sides of Equation (16) gives

$${F}_{t , x , y , z} \{ {H}_{z} \{ g ( t , x , y , z ) \} \} = - \frac{{D}_{t , x , y , z} ( ω , {k}_{x} , {k}_{y} , {k}_{z} )}{\vert {k}_{z} \vert} \qquad Equation ( 17 )$$

The dispersion relation of Equation (12) may be used to map the vertical wavenumber to the horizontal wavenumbers, and Equation (17) may be expressed as follows:

$${F}_{t , x , y , z} \{ {H}_{z} \{ g ( t , x , y , z ) \} \} = - \frac{{D}_{t , x , y , z} ( ω , {k}_{x} , {k}_{y} )}{\vert \sqrt{{( ω / v )}^{2} - {k}_{x}^{2} - {k}_{y}^{2}} \vert} \qquad Equation ( 18 )$$

At this point it is important to note that the right hand side of Equation (18) is no longer a function of the vertical coordinate z (or of k_{z}), and thus, F_{t,x,y,z}{H_{z}} may be estimated even if the signal g is a function of only time and horizontal coordinates. Then, for a signal g(t, x, y) Equation (18) reduces to:

$${F}_{t , x , y} \{ {H}_{z} \{ g ( t , x , y ) \} \} = - \frac{{D}_{t , x , y} ( ω , {k}_{x} , {k}_{y} )}{\vert \sqrt{{( ω / v )}^{2} - {k}_{x}^{2} - {k}_{y}^{2}} \vert} \qquad Equation ( 19 )$$

Without a dependency on the spatial coordinate z, Equation (18) may be used in Equation (11) to compute H_{z} for up/down wavefield separation. For example, for a wavefield p(t, x, y), the signal g(t, x, y) may be replaced by Hₜ{p(t, x, y)} in Equation (19) as follows:

$${F}_{t , x , y} \{ {H}_{z} \{ {H}_{t} \{ p ( t , x , y ) \} \} \} = - \frac{{F}_{t , x , y} \{ {H}_{t} \{ \frac{\partial }{\partial z} p ( t , x , y ) \} \}}{\vert \sqrt{{( ω / v )}^{2} - {k}_{x}^{2} - {k}_{y}^{2}} \vert} \qquad Equation ( 20 )$$

where the fact that the Hilbert Transform of a derivative of a signal is the derivative of the Hilbert Transform has been used. Furthermore, in some embodiments, time-space pressure data (315) acquired by seismic receivers (116) is a function of only one horizontal spatial coordinate, say x, and thus Equation (20) reduces even further to:

$${F}_{t , x} \{ {H}_{z} \{ {H}_{t} \{ p ( t , x ) \} \} \} = \frac{{F}_{t , x} \{ {H}_{t} \{ \frac{\partial }{\partial z} p ( t , x ) \} \}}{\vert \sqrt{{( ω / v )}^{2} - {k}_{x}^{2}} \vert} \qquad Equation ( 21 )$$

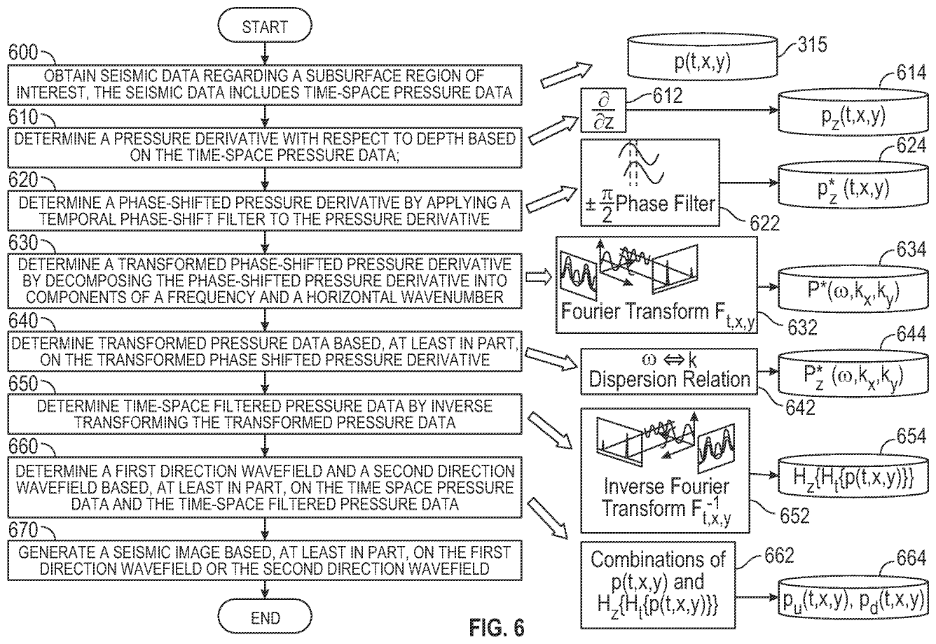

Turning to FIG. 6, FIG. 6 shows a flowchart in accordance with one or more embodiments. Specifically, FIG. 6 describes a general method to reduce surface reflections in seismic data. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, seismic data (302) associated with a subsurface region of interest is obtained, in accordance with one or more embodiments. The seismic data (302) may include time-space pressure data p(t, x, y) (315) acquired using a seismic acquisition system (100) above a subsurface region of interest (102). The seismic data (302) may be processed to attenuate noise and may be organized in one or more spatial dimensions (316, 318) and a time axis (314) to form a plurality of time-space waveforms. In some embodiments, a plurality of CSGs (310) may be generated with the source position corresponding to the middle of the offset, as illustrated in FIG. 3.

In Block 610, a pressure derivative with respect to depth is determined based on the time-space pressure data, in accordance with one or more embodiments. A derivative with respect to depth (612) may be estimated from two values of the wavefield p(t, x, y) at two different depths z₁ and z₂ as follows:

$${p}_{z} ( t , x , y ) = \frac{{p}_{2} ( t , x , y ) - {p}_{1} ( t , x , y )}{{z}_{2} - {z}_{1}} \qquad Equation ( 22 )$$

where p₁(t, x, y) and p₂(t, x, y) are the values of p(t, x, y) at depths z₁ and z₂, respectively. In some embodiments, the two depths z₁ and z₂ used to compute p_{z}(t, x, y) (614) correspond to the over streamer (216) and the under streamer (218) of a seismic acquisition system (100). In other embodiments, the seismic acquisition system (100) includes only one streamer (214) and the two depths z₁ and z₂ to compute the pressure derivative p_{z}(t, x, y) (614) are the free surface and the streamer's depth.

In Block 620, a phase-shifted pressure derivative is determined by applying a temporal phase-shift filter to the pressure derivative, in accordance with one or more embodiments. A phase filter (622) may be used to apply a ±π/2 temporal phase shift to the pressure derivative with respect to depth p_{z}(t, x, y) (614). In some embodiments the phase-shifted pressure derivative p_{z}^{*}(t, x, y) (624) may be obtained via the Hilbert Transform Hₜ:

$${p}_{z}^{*} ( t , x , y ) = {H}_{t} \{ {p}_{z} ( t , x , y ) \} \qquad Equation ( 23 )$$

Filtering with the phase filter (622) may be performed in the time-domain, or the in the temporal frequency ω-domain, for example, with Eq. (4) or with Eq. (6).

In Block 630, a transformed phase-shifted pressure derivative is determined by decomposing the phase-shifted pressure derivative into components of a frequency and a horizontal wavenumber, in accordance with one or more embodiments. The transformed phase-shifted pressure derivative [symbol] (ω, kₓ, k_{y}) (634) may be obtained by transforming the phase-shifted pressure derivative p_{z}^{*}(t, x, y) (624) with multidimensional Fourier Transforms. For example, the transformation of the phase-shifted pressure derivative p_{z}^{*}(t, x, y) (624) may be expressed as follows:

$$( ω , {k}_{x} , {k}_{y} ) = {F}_{t , x , y} \{ {p}_{z}^{*} ( t , x , y ) \} \qquad Equation ( 24 )$$

where F_{t,x,y}(632) is the Fourier Transform applied to the time variable and to the x- and y-spatial coordinates. Therefore, the transformed phase-shifted pressure derivative [symbol] (ω, kₓ, k_{y}) (634) is a function of the temporal frequency ω and the wavenumbers kₓ and k_{y}.

In Block 640, transformed phase-shifted pressure data is determined based on the transformed phase-shifted pressure derivative, in accordance with one or more embodiments. The transformed phase-shifted pressure derivative [symbol] (ω, kₓ, k_{y}) (634) may be processed to obtain transformed phase-shifted pressure data [symbol] (ω, kₓ, k_{y}) (644) that is related to the Hilbert Transform with respect to depth H_{z}. The relation may be expressed as:

$$( ω , {k}_{x} , {k}_{y} ) = {F}_{t , x , y} \{ {H}_{z} \{ {H}_{t} \{ p ( t , x , y ) \} \} \} \qquad Equation ( 25 )$$

Equation (25) indicates that the function [symbol] (ω, kₓ, k_{y}) (644) is the Fourier transform F_{t,x,y} (632) of the desired Hilbert Transform with respect to depth H_{z}. On the other hand, functions [symbol] (ω, kₓ, k_{y}) (644) and [symbol] (ω, kₓ, k_{y}) (634) are related by the dispersion relation (642) given by Eq. (12):

$$( ω , {k}_{x} , {k}_{y} ) = \frac{( ω , {k}_{x} , {k}_{y} )}{\vert \sqrt{{( ω / v )}^{2} - {k}_{x}^{2} - {k}_{y}^{2}} \vert} \qquad Equation ( 26 )$$

Equation (26) makes it possible the computation of the Hilbert Transform with respect to depth H_{z} when the time-space pressure data p(t, x, y) (315) is not a function the vertical coordinate z, as it may be the case of marine seismic data (302) acquired with one or two streamers (216, 218).

In Block 650, time-space filtered pressure data is determined by inverse transforming the transformed phase-shifted pressure data, in accordance with one or more embodiments. Time-space filtered data (654) may correspond to the time-space pressure data p(t, x, y) (315) being applied a temporal phase filter and a spatial-phase filter. In terms of Hilbert Transforms the time-space filtered data (654) may be expressed as H_{z}{Hₜ{p(t, x, y)}}. Applying the inverse Fourier Transform (652) to Eq. (25) the time-space filtered data (654) is then obtained:

$${H}_{z} \{ {H}_{t} \{ p ( t , x , y ) \} \} = {F}_{t , x , y}^{- 1} \{ ( ω , {k}_{x} , {k}_{y} ) \} \qquad Equation ( 27 )$$

In Block 660, a first direction wavefield and a second direction wavefield are determined based on the time-space pressure data and the time-space filtered pressure data, in accordance with one or more embodiments. The separation of the wavefield in a first direction wavefield and a second direction wavefield may be performed in the frequency-wavenumber domain, according to some embodiments. In other implementations, the separation of the wavefield may be performed in the time-space domain by applying the Extended Hilbert Transform. In one or more embodiments, the first direction and second direction wavefields may correspond to upgoing waves (510) and downgoing waves (508), respectively. The separation of the time-space pressure data p(t, x, y) (315) into two wavefields pᵤ(t, x, y) and p_{d}(t, x, y) (664) may be determined by linear combinations (662) of the time-space pressure data (315) and the time-space filtered pressure data (654), using the following equation:

$${p}_{u} ( t , x , y ) = \frac{1}{2} p ( t , x , y ) + \frac{1}{2} {H}_{z} \{ {H}_{t} \{ p ( t , x , y ) \} \} \\ {p}_{d} ( t , x , y ) = \frac{1}{2} p ( t , x , y ) - \frac{1}{2} {H}_{z} \{ {H}_{t} \{ p ( t , x , y ) \} \} \qquad Equation ( 28 )$$

In Block 670, a seismic image (330) is generated based on the first direction wavefield or the second direction wavefield. In some embodiments, seismic data (302) may be processed to extract the deghosted upgoing waves (510) from the time-space waveforms, because they carry information about the geological discontinuities (112) or reflectors in the subsurface region of interest (102). In some embodiments, the first direction wavefield may correspond to the upgoing waves (510), and in other embodiments, the second direction wavefield may correspond to the upgoing waves (510).

In one or more embodiments, extraction of deghosted upgoing waves (510) may be performed for each of a plurality of CSGs (304), and the plurality of filtered CSGs may then be used by the seismic processor (320) to generate a seismic image (330). For example, a partial seismic image may be generated for each of the plurality of filtered CSGs obtaining a plurality of partial seismic images. A stacked seismic image may then be constructed, for example, by summing all the partial seismic images.

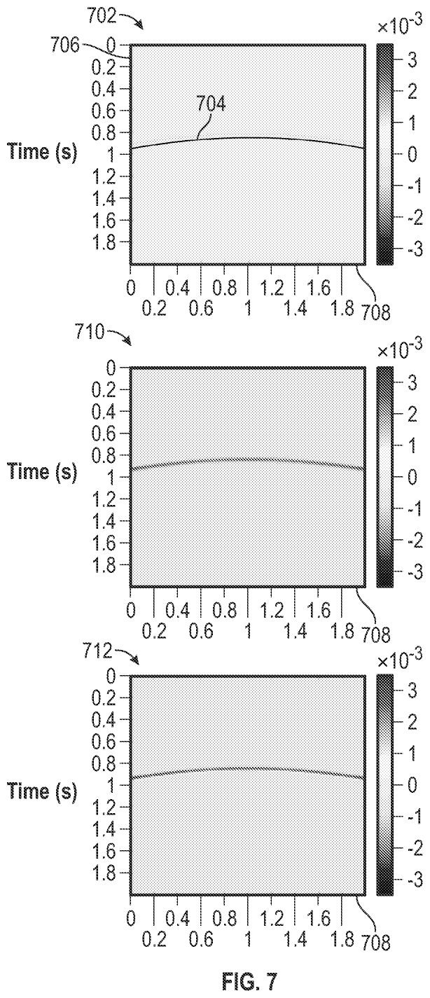

As concrete examples of the methods, processes, models, and techniques described herein, up/down wavefield separation was performed following the method described in FIG. 6 on both simulated and real seismic datasets. Specifically, FIG. 7 shows a common shot gather (CSG) (702) including a reflective event (704) propagating in medium with one layer over a half-space (or equivalently, a medium with one reflector), according to one or more embodiments. The vertical axis (706) indicates the time in seconds and the horizontal axis (708) indicates a horizontal spatial coordinate. The reflective event (704) includes upgoing waves (510) and downgoing waves (508) as described in FIG. 5. The results of separating the fields are illustrated in CSG (710) and (712) corresponding to upgoing and downgoing waves, respectively. As seen in FIG. 7, the two wavefields are completed separated.

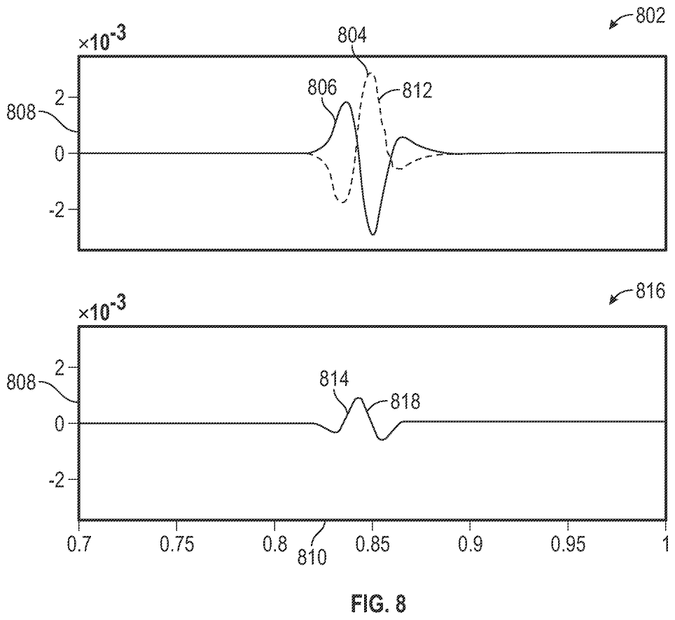

The results of the wavefield separation in the example described above are further illustrated in the waveforms of FIG. 8. Panel (802) shows the waveforms of the upgoing wave (804) and a downgoing wave (806) obtained from deghosting the wavefield in CSG (702). The vertical axis (808) indicates the waveform amplitude, and the horizontal axis (810) indicates the time in seconds. The deghosted upgoing waves (804) and downgoing waves (806) appear to have opposite phases and a short time shift, which depends on the depth of the seismic receivers (116) and the velocity of the body of water. Further, the waveform of the theoretical up-going wave (812) is also shown in FIG. 8, being almost identical to the waveform of the deghosted upgoing wave (804). The addition (814) of waveforms (804) and (806), shown in panel (816), is equivalent to the originally simulated waveform (818), also shown in panel (816), illustrating that the disclosed wavefield separation method does not cause energy losses.

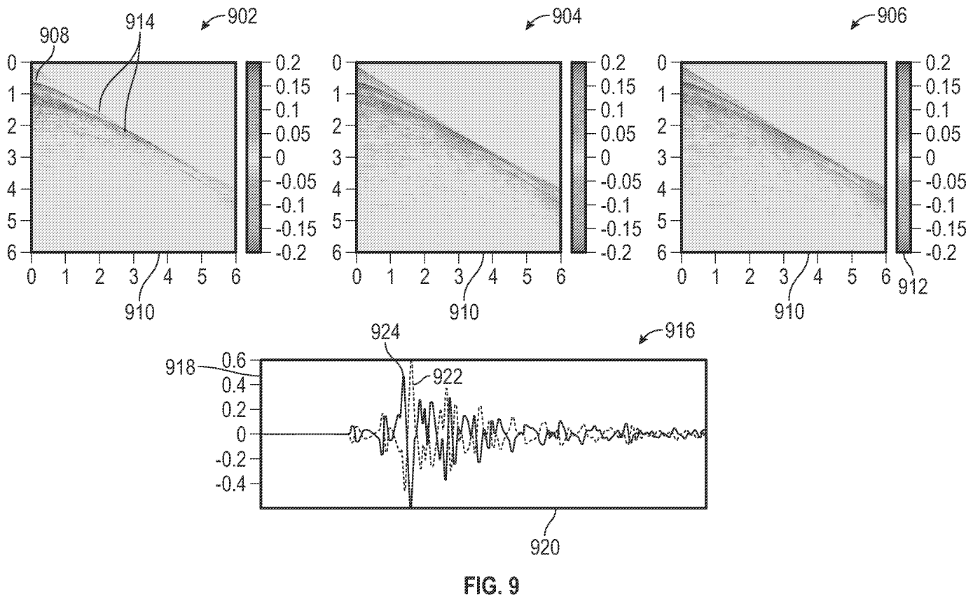

Turning to FIG. 9, FIG. 9 illustrates recorded and separated wavefields organized in CSGs, according to one or more embodiments. CSG (902) shows time-space pressure data (315) acquired with a marine single streamer (214). The deghosted upgoing and downgoing wavefields are shown in CSG (904) and (906) respectively. In CSGs (902)-(906) the time scale is indicated by the vertical axis (908) and a horizontal spatial coordinate is indicated by the horizontal axis (910). The amplitude of the pressure field is indicated by the vertical scale bar (912). As seen, CSG (902) includes numerous reflectivity events (914). Once again, the results of the presently disclosed method may be further visualized by comparing waveforms as shown in panel (916). The vertical axis (918) and the horizontal axis (920) in panel (916) indicate the waveform amplitude and the time scales, respectively. Waveforms of deghosted upgoing waves (922) and downgoing waves (924) have opposite phases and a small time shift, similar to the time shift of the separated wavefields shown in FIG. 8.

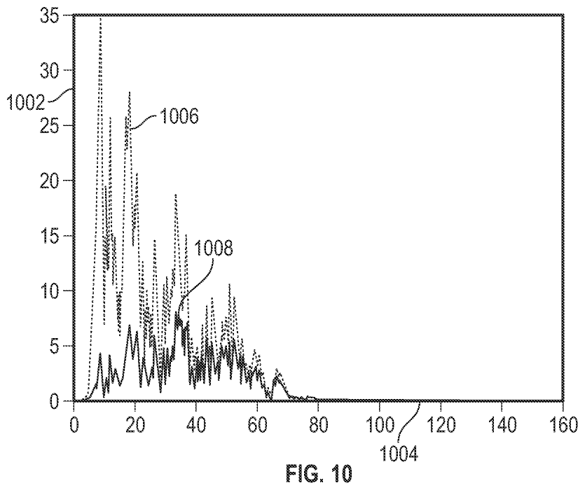

As a final comparison, FIG. 10 shows the spectrum of the waveform of upgoing waves (922) and the spectrum of the corresponding waveform of the input waves that were separated. The two waveforms are transformed with the Fourier Transform, and thus the vertical axis (1002) in FIG. 10 indicates the amplitude of the Fourier Transform and the horizontal axis (1004) indicates the frequency in Hz. FIG. 10 illustrates the significant difference in the spectrum of the deghosted upgoing waveform (1006) and the spectrum of the input waveform (1008) for all frequencies. Comparison of the two spectra (1006, 1008) makes evident the destructive interference resulting from the ghosting wavefield. By applying the proposed up/down wavefield separation method a better estimate of the upgoing waves (922) may be obtained, especially for the spectral amplitudes at low frequencies, as shown in FIG. 10. The use of the deghosted upgoing waves (510) may then allow the generation of seismic images (330) with higher accuracy and resolution.

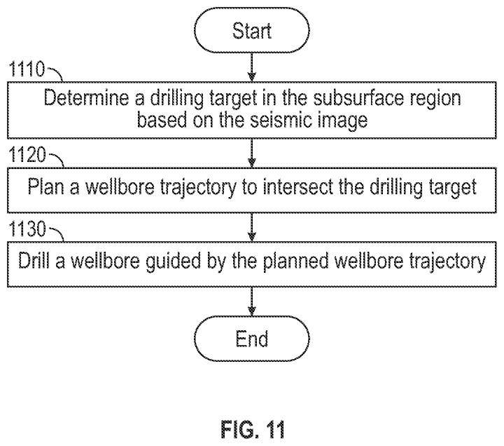

FIG. 11 describes a method to use the deghosted wavefield to determine a drilling target to drill a wellbore, in accordance with one or more embodiments. In Block 1110, a drilling target in the subsurface region may be determined based on the seismic image, in accordance with one or more embodiments. The seismic processor (320) may transfer the seismic image (330) to the seismic interpretation workstation (436). The seismic interpretation workstation (436) may determine a drilling target (430) in a wellbore (118) based on, for example, an expected presence of gas or another hydrocarbon. Locations in a seismic image (330) may indicate an elevated probability of the presence of a hydrocarbon and may be targeted by well designers. On the other hand, locations in a seismic image (330) indicating a low probability of the presence of a hydrocarbon may be avoided by well designers.

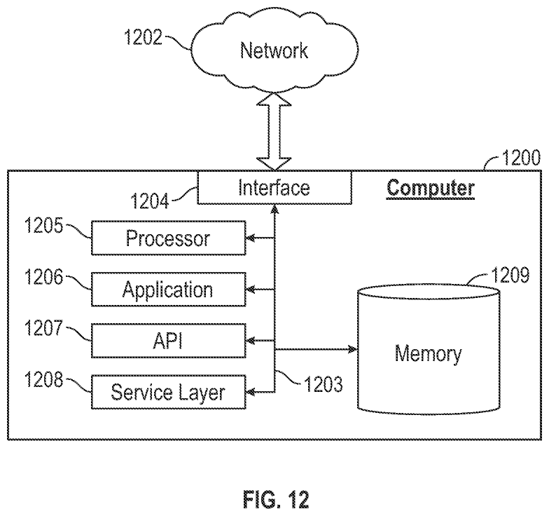

In Block 1120, a wellbore trajectory to intersect the drilling target is planned using the seismic image, in accordance with one or more embodiments. Knowledge of the location of the drilling target (430) and the seismic image (330) may be transferred to a wellbore planning system (438). Instructions associated with the wellbore planning system (438) may be stored, for example, in the memory (1209) within the computer system (1200) described in FIG. 12 below. The wellbore planning system (438) may use the knowledge of the location of the drilling target (430) and of the seismic image (330) to plan a wellbore trajectory (404) within the subterranean region of interest (102).

In Block 1130, a wellbore is drilled guided by the planned wellbore trajectory, in accordance with one or more embodiments. The wellbore planning system (438) may transfer the planned wellbore trajectory (404) to the drilling system (400) described in FIG. 4. The drilling system (400) may drill the wellbore (118) along the planned wellbore trajectory (404) to access and produce the hydrocarbon reservoir (104) to the surface (124, 208).

In some embodiments the wellbore planning system (438), the seismic processor (320) and the seismic interpretation workstation (436) may each be implemented within the context of a computer system. FIG. 12 is a block diagram of a computer system (1200) used to provide computational functionalities associated with described algorithms, methods, functions, processes, flows, and procedures as described in the instant disclosure, according to an implementation. The illustrated computer (1200) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1200) may include a computer that includes an input device, such as a keypad, keyboard, touch screen, or other device that can accept user information, and an output device that conveys information associated with the operation of the computer (1200), including digital data, visual, or audio information (or a combination of information), or a GUI.

The computer (1200) can serve in a role as a client, network component, a server, a database or other persistency, or any other component (or a combination of roles) of a computer system for performing the subject matter described in the instant disclosure. The illustrated computer (1200) is communicably coupled with a network (1202). In some implementations, one or more components of the computer (1200) may be configured to operate within environments, including cloud-computing-based, local, global, or other environment (or a combination of environments).

At a high level, the computer (1200) is an electronic computing device operable to receive, transmit, process, store, or manage data and information associated with the described subject matter. According to some implementations, the computer (1200) may also include or be communicably coupled with an application server, e-mail server, web server, caching server, streaming data server, business intelligence (BI) server, or other server (or a combination of servers).

The computer (1200) can receive requests over network (1202) from a client application (for example, executing on another computer (1200)) and responding to the received requests by processing the said requests in an appropriate software application. In addition, requests may also be sent to the computer (1200) from internal users (for example, from a command console or by other appropriate access method), external or third-parties, other automated applications, as well as any other appropriate entities, individuals, systems, or computers.

Each of the components of the computer (1200) can communicate using a system bus (1203). In some implementations, any or all of the components of the computer (1200), both hardware or software (or a combination of hardware and software), may interface with each other or the interface (1204) (or a combination of both) over the system bus (1203) using an application programming interface (API) (1207) or a service layer (1208) (or a combination of the API (1207) and service layer (1208). The API (1207) may include specifications for routines, data structures, and object classes. The API (1207) may be either computer-language independent or dependent and refer to a complete interface, a single function, or even a set of APIs. The service layer (1208) provides software services to the computer (1200) or other components (whether or not illustrated) that are communicably coupled to the computer (1200). The functionality of the computer (1200) may be accessible for all service consumers using this service layer (1208). Software services, such as those provided by the service layer (1208), provide reusable, defined business functionalities through a defined interface. For example, the interface may be software written in JAVA, C++, or other suitable language providing data in extensible markup language (XML) format or other suitable format. While illustrated as an integrated component of the computer (1200), alternative implementations may illustrate the API (1207) or the service layer (1208) as stand-alone components in relation to other components of the computer (1200) or other components (whether or not illustrated) that are communicably coupled to the computer (1200). Moreover, any or all parts of the API (1207) or the service layer (1208) may be implemented as child or sub-modules of another software module, enterprise application, or hardware module without departing from the scope of this disclosure.

The computer (1200) includes an interface (1204). Although illustrated as a single interface (1204) in FIG. 12, two or more interfaces (1204) may be used according to particular needs, desires, or particular implementations of the computer (1200). The interface (1204) is used by the computer (1200) for communicating with other systems in a distributed environment that are connected to the network (1202). Generally, the interface (1204) includes logic encoded in software or hardware (or a combination of software and hardware) and operable to communicate with the network (1202). More specifically, the interface (1204) may include software supporting one or more communication protocols associated with communications such that the network (1202) or interface's hardware is operable to communicate physical signals within and outside of the illustrated computer (1200).

The computer (1200) includes at least one computer processor (1205). Although illustrated as a single computer processor (1205) in FIG. 12, two or more processors may be used according to particular needs, desires, or particular implementations of the computer (1200). Generally, the computer processor (1205) executes instructions and manipulates data to perform the operations of the computer (1200) and any algorithms, methods, functions, processes, flows, and procedures as described in the instant disclosure.

The computer (1200) also includes a memory (1209) that holds data for the computer (1200) or other components (or a combination of both) that may be connected to the network (1202). For example, memory (1209) may be a database storing data consistent with this disclosure. Although illustrated as a single memory (1209) in FIG. 12, two or more memories may be used according to particular needs, desires, or particular implementations of the computer (1200) and the described functionality. While memory (1209) is illustrated as an integral component of the computer (1200), in alternative implementations, memory (1209) may be external to the computer (1200).

The application (1206) is an algorithmic software engine providing functionality according to particular needs, desires, or particular implementations of the computer (1200), particularly with respect to functionality described in this disclosure. For example, application (1206) can serve as one or more components, modules, applications, etc. Further, although illustrated as a single application (1206), the application (1206) may be implemented as multiple applications (1206) on the computer (1200). In addition, although illustrated as integral to the computer (1200), in alternative implementations, the application (1206) may be external to the computer (1200).

There may be any number of computers (1200) associated with, or external to, a computer system containing computer (1200), each computer (1200) communicating over network (1202). Further, the term “client,” “user,” and other appropriate terminology may be used interchangeably as appropriate without departing from the scope of this disclosure. Moreover, this disclosure contemplates that many users may use one computer (1200), or that one user may use multiple computers (1200).

In some embodiments, the computer (1200) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining seismic data regarding a subsurface region of interest, wherein the seismic data comprises time-space pressure data; and
using a seismic processor:
determining a pressure derivative with respect to depth based on the time-space pressure data;
determining a phase-shifted pressure derivative by applying a phase-shift filter to the pressure derivative;
determining a transformed phase-shifted pressure derivative by decomposing the phase-shifted pressure derivative into components of a frequency and a horizontal wavenumber;
determining transformed phase-shifted pressure data based, at least in part, on the transformed phase-shifted pressure derivative;
determining time-space filtered pressure data by inverse transforming the transformed phase-shifted pressure data;
determining a first direction wavefield and a second direction wavefield based, at least in part, on the time-space pressure data and the time-space filtered pressure data; and
generating a seismic image based, at least in part, on the first direction wavefield or the second direction wavefield.

2. The method of claim 1, further comprising:
determining, using a seismic interpretation workstation, a drilling target in the subsurface region based on the seismic image.

3. The method of claim 2, further comprising:
planning, using a wellbore planning system, a planned wellbore trajectory to intersect the drilling target; and
drilling, using a drilling system, a wellbore guided by the planned wellbore trajectory.

4. The method of claim 1, wherein the phase-shift filter is based on a Hilbert Transform.

5. The method of claim 1, wherein determining a transformed phase-shifted pressure derivative comprises performing Fourier Transforms.

6. The method of claim 1, wherein determining the first direction wavefield or the second direction wavefield comprises a linear combination of the time-space pressure data and the time-space filtered pressure data.

7. The method of claim 1, wherein determining transformed phase-shifted pressure data comprises using a relation between the vertical wavenumber and at least one horizontal wavenumber.

8. The method of claim 1, wherein the time-space pressure data is acquired at a plurality of pairs of receivers, wherein the receivers of each pair are placed at a same horizontal location but at two different depths.

9. A non-transitory computer-readable medium comprising computer-executable instructions stored thereon that, when executed on by processor, cause the processor to perform steps comprising:
obtaining seismic data regarding a subsurface region of interest, wherein the seismic data comprises time-space pressure data;
determining a pressure derivative with respect to depth based on the time-space pressure data;
determining a phase-shifted pressure derivative by applying a phase-shift filter to the pressure derivative;
determining a transformed phase-shifted pressure derivative by decomposing the phase-shifted pressure derivative into components of a frequency and a horizontal wavenumber;
determining transformed phase-shifted pressure data based, at least in part, on the transformed phase-shifted pressure derivative;
determining time-space filtered pressure data by inverse transforming the transformed phase-shifted pressure data;
determining a first direction wavefield and a second direction wavefield based, at least in part, on the time-space pressure data and the time-space filtered pressure data; and
generating a seismic image based, at least in part, on the first direction wavefield or the second direction wavefield.

10. The non-transitory computer-readable medium of claim 9, wherein the steps further comprise:
determining a drilling target in the subsurface region based on the seismic image.

11. The non-transitory computer-readable medium of claim 9, wherein the steps further comprise:
determining the first direction wavefield or the second direction wavefield using a linear combination of the time-space pressure data and the time-space filtered pressure data.

12. The non-transitory computer-readable medium of claim 9, wherein the steps further comprise:
determining transformed phase-shifted pressure data using a relation between the vertical wavenumber and at least one horizontal wavenumber.

13. A system, comprising:
a seismic acquisition system configured to record seismic data regarding a subsurface region of interest, wherein the seismic data comprises time-space pressure data; and
a seismic processor configured to:
obtain the seismic data regarding the subsurface region of interest,
determine a pressure derivative with respect to depth based on the time-space pressure data,
determine a phase-shifted pressure derivative by applying a phase-shift filter to the pressure derivative,
determine a transformed phase-shifted pressure derivative by decomposing the phase-shifted pressure derivative into components of a frequency and a horizontal wavenumber,
determine transformed phase-shifted pressure data based, at least in part, on the transformed phase-shifted pressure derivative,
determine time-space filtered pressure data by inverse transforming the transformed phase-shifted pressure data,
determine a first direction wavefield and a second direction wavefield based, at least in part, on the time-space pressure data and the time-space filtered pressure data, and
generate a seismic image based, at least in part, on the first direction wavefield or the second direction wavefield.

14. The system of claim 13, further comprising a seismic interpretation workstation configured to determine a drilling target in the subsurface region based on the seismic image.

15. The system of claim 14, further comprising a wellbore planning system configured to plan a planned wellbore trajectory based, at least in part, on the seismic image.

16. The system of claim 15, further comprising a drilling system configured to drill a portion of a wellbore guided by the planned wellbore trajectory.

17. The system of claim 13, wherein the seismic processor is further configured to:
determine the first direction wavefield or the second direction wavefield using a linear combination of the time-space pressure data and the time-space filtered pressure data.

18. The system of claim 13, wherein the seismic processor is further configured to:
determine transformed phase-shifted pressure data using a relation between the vertical wavenumber and at least one horizontal wavenumber.

19. The system of claim 13, wherein the time-space pressure data is acquired at a plurality of pairs of receivers, wherein the receivers of each pair are placed at a same horizontal location but at two different depths.

20. The system of claim 13, wherein the phase-shift filter is based on a Hilbert Transform.
